(19) United States
(12) Patent Application Publication
(10) Pub. No.: US 2025/0012569 A1
(43) Pub. Date: Jan. 9, 2025

(54) Systems and Methods for Determining a Boundary for a Real Estate Parcel Based Upon Signals from a Beacon Apparatus

(71) Applicant: Carter & Clark, LLC, Lawrenceville, GA (US)

(72) Inventors: Brandon Palmer Ansley, Atlanta, GA (US); Gavin Paul Bacchus, Sugar Hill, GA (US)

(21) Appl. No.: 18/761,827

(22) Filed: Jul. 2, 2024

Related U.S. Application Data
(60) Provisional application No. 63/524,713, filed on Jul. 3, 2023.

(51) Int. Cl. G01C 15/04

(52) U.S. Cl. CPC G01C 15/04

(57) ABSTRACT

Disclosed are embodiments for determining a location of boundary pins and the boundary associated with a land parcel. One embodiment, among others, is a system that includes a plurality of boundary pins associated with a particular parcel of land, a plurality of beacons associated with respective boundary pins, and a mobile communications device (MCD). Each beacon is designed to transmit a signal, each signal indicative of a respective location of the respective pin. The MCD has a processing system that executes instructions associated with a land survey application program. The land survey application program is designed to receive the signals transmitted by the beacons and to output location information to a user so that the user can locate the plurality of pins. In some embodiments, the MCD can display a boundary of the particular parcel of property on a map by accessing survey and map information.

### CLAIM OF PRIORITY

The present application claims priority to and the benefit of application No. 63/524,713, filed Jul. 3, 2023, which is incorporated herein by reference in its entirety.

### FIELD OF THE INVENTION

The present invention generally relates to land surveying, and more particularly, to an automated system for determining a boundary of a real estate parcel.

### BACKGROUND OF THE INVENTION

The U.S., like nearly every other capitalist nation, formally recognizes and protects an individual's right to private ownership of real property. A core (yet often overlooked and/or forgotten) requirement for any civilized society permitting private ownership of real property is a collectively agreed upon system for determining and establishing property boundaries—the specific locations on the earth where one parcel of property ends, and another begins. Without a clear, accurate, and irrefutable system to reliably determine and communicate precise property boundaries, individual landowners would be unable to define or recognize the location and limits of their land, leaving neighboring property owners in constant dispute over property boundaries with no unifying source to reference.

This need to implement a universal system for establishing, recording, and visually depicting property boundaries (a system that remains a critical and fundamental component of all real estate, property development and construction transactions to this day) ultimately spawned a multi-billion-dollar professional industry in the U.S.—what is now referred to as the land surveying industry.

“Surveying” is defined as “[t]he science and art of making all essential measurements in space to determine the relative positions of points and/or physical . . . details . . . on the earth's surface and to depict them in usable form.” Land Surveying is, more specifically, the practice of accurately measuring the physical features and characteristics of a particular piece of land/property for the purpose of depicting the property in an accurately scaled, usable format. The finished illustration is commonly referred to as a “Land Survey” or “Property Survey.”

The commercial practice of land surveying requires a professional license from the state in which the survey is to be performed. Licensure may only be obtained by individuals who can demonstrate evidence of the requisite training, educational requirements, and professional experience in the field of land surveying. Upon state licensure, these individuals become “Professional Land Surveyors (PLSs).

PLSs are granted the authority from each state to formally determine and establish property lines and boundaries in accordance with the laws, rules and regulations of the licensing state. The property lines/boundaries established by the PLS—which are visually depicted in the form of a representative illustration of the property—are then recorded and kept on file with the appropriate local jurisdiction.

There are 1.3 billion acres of privately owned land in the United States, which consists of more than 99 million separate and individual parcels of land. The recorded terrestrial locations of the property lines and boundaries of each and every one of these parcels was established from a PLS' illustration of his/her measurements of the property. It is on the shoulders of this system—a drawing of the on-site measurements taken and transcribed by a PLS—that the entirely of private land ownership in the U.S. rests.

A system such as this, which contains inherent flaws and gaps, is not 100% accurate. As such, there are thousands of property boundary disputes across the U.S. each year. Many property owners purchase title insurance to guard against the risk that they do not really own what they believe they purchased.

### A. The Land Surveying Process

A land survey is a visual representation of a portion of land that is used to illustrate the property's exact shape, location, dimensions, and boundaries in the form of a drawing. Land surveys may also include depictions of other physical features (both natural and manufactured) of the surveyed property. Although there are many different types of land surveys—survey type, and thus the universe of information depicted on the related drawing, ultimately depends on the purpose for which the survey is performed—the types of surveys referenced in this document are the surveys relating to (and commonly required in) real estate and construction transactions, which are generally referred to as property surveys (among property surveys, the most commonly recognized iteration is a “Boundary Survey,” which is used for determining the exact and precise location of the border/boundaries of a particular property).

A standard residential survey typically consists of establishing the property corners and property lines, showing both the measured and record bearings on the document. The home is located and represented on the survey with dimensions of the residence and distances to the property lines. In addition to the home, any permanent structures such as carports, sheds, patios and swimming pools are located and shown graphically on the survey as well. FIG. 1 shows a representative examples of property surveys.

### 1) Step One: On-Site Data Collection & Measurements

The creation of a precise, properly scaled visual representation depicting a property and its relevant physical features (including all appropriate measurements, distances, property boundaries/borders, etc.) requires that the PLS first visit the property to collect data and perform all appropriate & necessary measurements.

Because the on-site collection of data & measurements is a laborious and time-consuming process that requires demanding precision, highly specialized instruments and equipment have been developed over the years to assist PLSs with this process. This equipment helps efficiently gather data (i.e. measures distances, angles and elevations) with a high degree speed, accuracy and precision. It also eliminates having to measure each and every dimension and angle of the subject property because the equipment can quickly perform complex mathematical calculations which leverage the data from a few fundamental datapoints to accurately extrapolate any/all additional dimensional data/measurements (i.e., the equipment's onboard computers use sophisticated, pre-set plane geometry and trigonometry formulas to determine any other data points required for accurate dimensional representation).

a) “Control Points”-Proper Orientation with the Local Coordinate System

In addition to showing the physical measurements and characteristics of a particular parcel of land (i.e., the length of each boundary, the total area of the property, etc.), property surveys also depict and describe the exact physical position that the subject property occupies in relation to adjoining/nearby parcels. Not unlike a singular piece of a complex jigsaw puzzle, a property survey must also precisely fit and align with any/all corresponding geospatial information that depicts the property's location such as maps, aerial photography, or satellite imagery as well.

Simply put, all accurate property surveys require the PLS to locate a known “starting point” from which to orient his/her equipment and begin initial measurements. In some cases, this “starting point” may be a nearby landmark or some other easily identifiable location point wherein the exact local coordinates are already known. It is important to note that, while some land surveys make use of global positioning technology where coordinates are calculated using the latitude and longitude coordinate system of the entire globe, the majority of land surveys utilize local coordinate systems that are referenced off of the control points established for the project. In large construction projects or developments—or whenever it is clear at the outset of the project that multiple surveys involving the property will likely need to be performed in the future—permanent “control points” are often installed early in the development process to provide built-in “starting points” for future surveys.

These Control Points are fixed locations on the ground (typically marked with a permanent monument such as a metal pin or concrete post) on which the exact location coordinates of such point have been previously measured and recorded. The location coordinates of a known, predetermined point provide the PLS with the aforementioned “starting point” from which to initiate all subsequent measurements while ensuring consistency with adjacent properties.

Modern surveying equipment will accurately orient itself to the local coordinate system (and thus ensure proper positioning) if directed to and properly placed upon at least two Control Points. At that point, the PLS can direct the instrument to triangulate its relative location from the supplied coordinates of the two known control points, thereby ensuring proper orientation of the instrument with the local coordinate system and, in turn, accurate and consistent depiction of the property's relative position. Alternatively, an instrument can be set up at an arbitrary location, using two known locations to orient the instrument. This is sometimes referred to as Free Station Surveying. Free Station Surveying is useful when the location of the control points is not conducive to the measurements needed for the task being performed.

b) Survey Monuments-Marking Property Corners (i.e. Boundary Pins)

Most state laws require that, as part of the property surveying process, all PLSs install a permanent monument (i.e. marker) in the ground of each corner of the subject property's boundary (unless a pre-existing monument properly and accurately identifying the corner is already present). The purpose of these monuments is to provide a visual representation of the precise, certifiable terrestrial location, as measured by a trained & licensed professional land surveyor, of each property's boundary corners (for clarity and ease of reference, these required corner monuments are hereinafter referred to as “boundary pin(s)”). These monuments are called a variety of terms, including: “survey pins,” “property pins,” “boundary pins,” “corner pins,” “boundary stakes,” etc.

Although the exact size, shape, dimensions and/or material used for boundary pins may vary slightly from one geographic location to the next (depending on any state, local or other jurisdiction-specific requirements), the most common approach includes an 18-24 inch metal rod with a specially-designed “cap” that is affixed to the top of the rod during installation. The “cap”—typically made of rugged, weather-proof plastic or rubber and custom-made specifically for this purpose (hereinafter referred to as “Pin Caps”)—is securely affixed to the top of the metal rod. Once the assembly is installed into the ground, the top of the Pin Cap is supposed to remain flush with the surface of the ground and thus visible from above. Each Pin Cap displays the license number (and/or other ID info, depending on the local requirements) of the PLS who performed the property survey.

The regulations promulgated by, for example, the State of Georgia, provide a clear explanation regarding why states require boundary pins, stating that “[i]n order to prevent boundary conflicts, the public must have assurances that the corners of real property boundaries as determined from an accurate survey are durably marked with survey monuments . . . ” The challenge with the existing products and methods in use today is that they do not achieve the desired outcome.

### 2) Step 2: Creating Visual Depiction of Property (and Related Measurements/Characteristics) and Additional Location Marking(s)

Using the data, measurements and information collected while on site, the PLS then creates a visual depiction of the property. The illustration shows the property corners and property lines, including all relevant measured and record bearings. If there is a structure located on the property, it will be accurately represented on the survey with dimensions of the structure and distances to the property lines. Any/all additional permanent structures—such as carports, sheds, patios and swimming pools—will be located and shown graphically on the survey as well.

Depending on the purpose of the survey, or the plans for the subject property, this may conclude the PLS' professional services. Many times, however, additional steps are needed.

For example, if construction is proposed on the property, the PLS may be asked to place temporary flags or stakes in the ground to indicate the exact location upon which to pour the structure's foundation (most commonly referred to as “staking” the property). The PLS may also be asked to generate a proposed “site plan” for the property, which depicts the location of the proposed structure (planned to be built) on the existing property.

### B. Existing Boundary Marker/Survey Pins-Common Challenges

Existing product and process:
1) Metal bar in the ground with plastic cap
2) Must visually locate boundary pin in ground for use as visual marker/monument
3) Metal detector often used as tool to assist with locating
4) Limited function/information
5) “Dumb” object: piece of metal in the ground as reference point

Outside of the land survey industry, it is not commonly understood (or even known) that the boundary corners on every single individual piece of property in the United States have been permanently marked with boundary pins by a professional land surveyor at some point in time. This simple fact—that despite the legal requirement to mark property corners, most landowners are unaware that their property's corners were ever marked with boundary pins—provides the most compelling evidence that the existing products/system fall short in achieving the desired result.

The existing practice and products currently in use to mark/identify property corners (i.e., the use of boundary pins), is rife with problems and challenges that generally fall into three main categories: (1) the manner in which boundary pins must be installed makes it extremely difficult to later find or locate them; (2) despite being permanently installed with pinpoint terrestrial accuracy, existing boundary pins (if located) communicate only a single data point: the location of one of the property's corners; and (3) the information provided by boundary pins can only be accessed upon visual, on-site observation of the object itself.

First, the manner in which boundary pins must be installed-flush with the ground-makes them extremely difficult to locate at a later date/time. Although many property owners are able to positively locate boundary pins after a careful search—sometimes even many years after they were installed—it is far more common that boundary pins cannot be found. Indeed, Countless websites and sources across the internet provide help/suggestions/tips to frustrated property owners unable to readily locate their property lines.

The only viable option available to most property owners needing to identify the accurate location of their property lines is to utilize the services of a local PLS. Doing so involves investing time and effort to find a reputable land surveying company, waiting days (or weeks) for the service to be performed, and typically costs in excess of $500 (price often depends on property size, and the average fee for larger properties regularly exceeds $1,000). Simply put, locating precise property lines/boundaries is a frustrating costly and time-consuming proposition for property owners.

Homeowners of recently constructed homes often face the most difficulty in locating boundary pins because construction on the property—bulldozers, heavy equipment, foot traffic and/or subsequent grading/landscaping after construction is complete—often cover boundary pins with dirt or soil, burying them under the ground and rendering them nearly impossible to locate.

Second, despite the complex (and highly accurate) process land surveyors must follow to identify the precise location of each property corner, which relies on and incorporates data from multiple nearby reference points, measurements, and complex mathematical formulas, existing boundary pins provide only a singular data point: a visual location marking one corner of the property. In other words, existing boundary pins are unable to provide (or otherwise communicate) any of the other valuable data, information and intelligence that was generated as a result of its installation (such as the boundary pin's exact coordinates, for example).

Third, existing boundary pins provide a visual point of reference regarding a property corner, but can only do so if the individual seeking such information is physically present and close enough to actually see the boundary pin itself. For anyone not physically present on the property, existing boundary pins provide no value or utility whatsoever.

### SUMMARY OF INVENTION

The present disclosure provides various embodiments for determining a location of boundary pins and the boundary associated with a land parcel.

One embodiment, among others, is an apparatus. The apparatus includes a boundary pin and a beacon. The boundary pin has an elongated body extending between first and second ends. The beacon is mounted to the boundary pin. The beacon is designed to transmit a signal to a mobile communications device (MCD). The signal is indicative of location information pertaining to the pin.

Another embodiment, among others, is a system. The system includes a plurality of boundary pins associated with a particular parcel of land, a plurality of beacons associated with respective boundary pins, and a mobile communications device (MCD). Each beacon is designed to transmit a signal, each signal indicative of a respective location of the respective pin. The MCD has a processing system that executes instructions associated with a land survey application program. The land survey application program is designed to receive the signals transmitted by the beacons and to output location information to a user so that the user can locate the plurality of pins. In some embodiments, the MCD can display a boundary of the particular parcel of property on a map by accessing survey and map information.

Another embodiment, among others, is another system. The system includes a plurality of boundary pins associated with a particular parcel of land, a plurality of beacons associated with respective boundary pins, and a mobile communications device (MCD). Each beacon is designed to transmit a signal, each signal indicative of a respective location of the respective pin. The MCD has a processing system that executes instructions associated with a land survey application program. The land survey application program is designed to receive the signals transmitted by the beacons, to determine a location of the pins, to create at least one property line of the land parcel, and to display the at least one property line on a map image. The at least one property line can be a complete boundary of the land parcel.

Another embodiment, among others, is a method. The method can be summarized by the following steps: (a) associating a beacon with a boundary pin of a land parcel, the boundary pin having an elongated body extending between first and second ends, the beacon being associated with the first end, the second end residing within the ground, the beacon designed to transmit a signal, the signal having first data that is indicative of a location of the pin; and (b) with a mobile communications device (MCD), executing instructions of a land survey application program with a processor in order to receive and analyze the signal transmitted by the beacon and to output location information to a user so that the user can locate the pin.

Another embodiment, among others, is a non-transitory computer readable medium storing a land survey application program causing a computer-based MCD to receive and analyze the signal transmitted by the beacon and to output location information to a user so that the user can locate the pin.

Another embodiment, among others, is another method. The method can be summarized by the following steps: (a) associating a beacon with a boundary pin of a land parcel, the boundary pin having an elongated body extending between first and second ends, the beacon being associated with the first end, the second end residing within the ground, the beacon designed to transmit a signal, the signal having first data that is indicative of a location of the pin; and (b) with a mobile communications device (MCD), executing instructions of a land survey application program with a processor in order to receive the signals transmitted by the beacons, to determine a location of each of the pins, to create at least one property line of the land parcel, and to display the at least one property line on a map image.

Another embodiment, among others, is a non-transitory computer readable medium storing a land survey application program causing a computer-based MCD to receive the signals transmitted by the beacons, to determine a location of each of the pins, to create at least one property line of the land parcel, and to display the at least one property line on a map image.

Another embodiment, among others, is a pin cap that can be placed on or otherwise associated with a boundary pin. The pin cap is provided with a beacon designed to transmit a signal that is indicative of a location of the pin cap.

Other embodiments, apparatus, systems, methods, features, and advantages of the present disclosure will be or become apparent to one with skill in the art upon examination of the following drawings and detailed description. It is intended that all such additional embodiments, apparatus, systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. The dimensions indicated in some of the figures are associated with a nonlimiting examples of an embodiment.

FIG. 1 shows an example of a land survey with boundary pins.

FIG. 2A shows the pin cap installed on a pin in the form of a metal rod.

FIG. 2B shows a cross sectional view of the pin cap and pin, with a beacon in accordance with the present disclosure.

FIG. 3 shows block diagram of an example of a beacon with on-board battery that can be embedded in or otherwise attached to the pin cap of FIG. 2, in accordance with the present disclosure.

FIG. 4 shows block diagram of an example of a mobile communications device (MCD) having a land survey app that can communicate with the one or more beacons and can communicate with the user via a user interface.

FIG. 5 is a flow chart illustrating a method that can be performed by using the MCD of FIG. 4, in accordance with the present disclosure.

FIG. 6 is a flow chart illustrating another method that can be performed by using the MCD of FIG. 4, in accordance with the present disclosure.

### DETAILED DESCRIPTION OF PREFERRED EMBODIMENT(S)

The embodiments of the present invention, particularly any preferred embodiments, that are described in the present disclosure are merely possible nonlimiting examples of implementations, merely set forth for a clear understanding of the principles of the invention. Many variations and modifications may be made to these embodiments without departing substantially from the spirit and principles of the invention. All such modifications and variations are intended to be included herein within the scope of this disclosure.

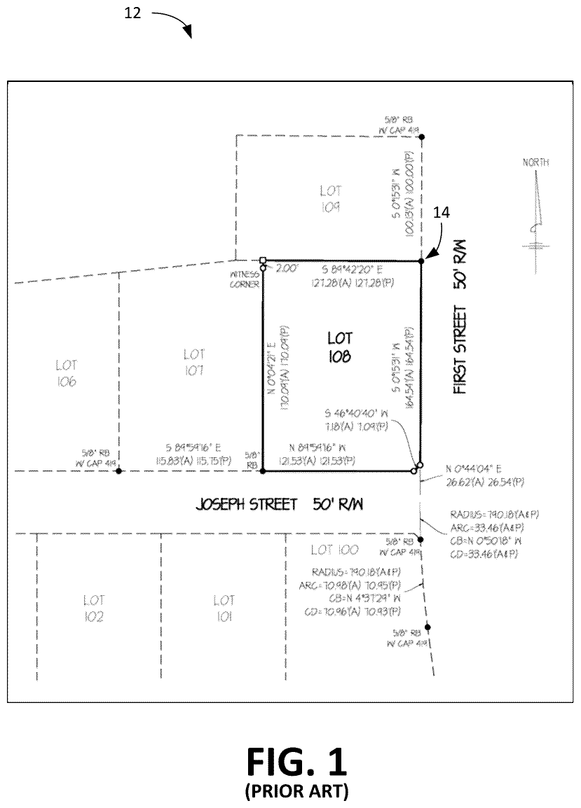

FIG. 1 shows an example of a land survey 12 with boundary pins 14. In this example, lot 108 has four boundary pins 14, one at each of its corners. In accordance with the present disclosure, each of the boundary pins 14, which is usually a metal rod measuring 18 inches to 24 inches, is equipped with a beacon that has been incorporated in (or permanently attached somewhere on) each pin 14 and that is capable of establishing a connection to and communicating with a mobile communications device (MCD). A land survey application program, or land survey app (or software), is executed on the MCD. In the preferred embodiment, the land survey application program generates a user interface that displays the data/information communicated from the boundary pin beacons 18. In essence, the existing technology of a boundary pin 14, which is a metal rod stuck in the ground, can be transformed into a smart device that broadcasts an encrypted digital signal that can be received to create a digital map of property.

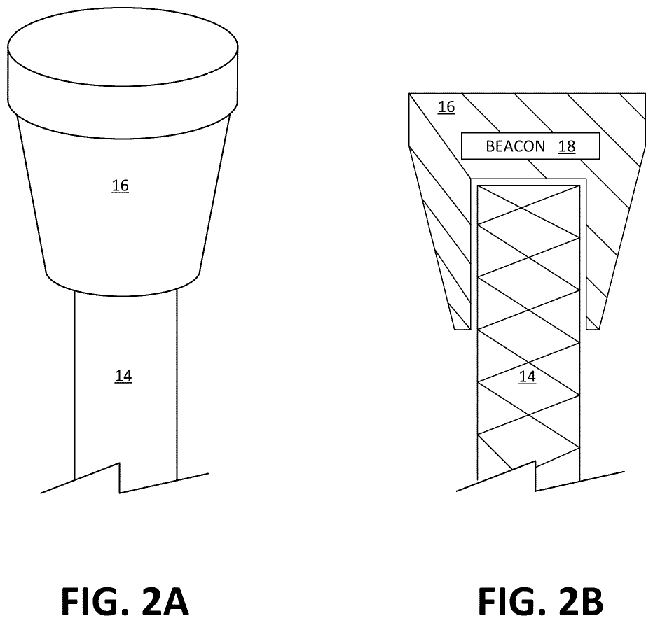

In the preferred embodiment, the beacon is incorporated into or otherwise associated with the pin cap 16 that is placed on the boundary pin 14. There are a variety of pin caps 16 that are commercially available for purchase. FIG. 2A shows an example of a pin cap, and the installation of the pin cap 16 onto the boundary pin 14. Pin caps 16 are typically plastic, rubber, or a durable weather-resistant material. FIG. 2B shows a beacon 18 embedded within a pin cap 16. The beacon 18 can be installed in the pin cap 16 during the manufacturing process. The beacon 18 can also be enclosed in its own housing, preferably weather-resistant, and then attached to or otherwise associated with the boundary pin 14.

### Beacon

A beacon 18 in the form of a battery powered transmitter (one-way unidirectional communication) or transceiver (two-way bidirectional communication with the MCD) is embedded into each pin cap 16 (or otherwise attached to or otherwise associated with each boundary pin).

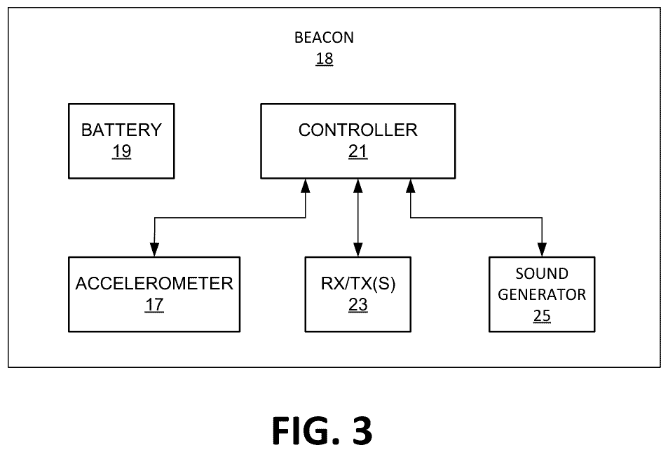

An electrical block diagram of the preferred embodiment of the beacon 18 is shown in FIG. 3. In the preferred embodiment, the beacon 18 is a radio transmitter integrated circuit chip with on-board battery and is able to electronically connect and communicate bidirectionally with the MCD. An example of a small chip-based beacon with an on-board battery that can be used is a Model YJ-15044-Ibeacon, which is manufactured by and commercially available from the Shenzhen Holyiot Technology Co. Ltd, located in Shenzhen Guangdon, China.

As shown in FIG. 3, the beacon 18 includes a battery 19 that provides electrical power to the circuit elements. A suitable controller 21 controls the requisite circuit software elements. The controller 21 can have circuit elements as well as both circuit and software elements. A transceiver 23 enables two-way bidirectional communications.

In some embodiments, as with the preferred embodiment, the beacon 18 can be equipped with a sound generator 25, which can be a speaker with audio driver circuit, a mechanical vibration mechanism, and/or some other suitable apparatus so that the beacon can chirp or otherwise make an audible signal on command from the land survey application program as a way of assisting with locating a boundary pin 14. The aforementioned beacon Model YJ-15044-Ibeacon has such a sound generator.

In some embodiments, as with the preferred embodiment, the beacon 18 can be equipped with an accelerometer 17, which can be used to determine if the beacon 18 has been moved (e.g., transported to a different place, disturbed, etc.). This is useful information that can be communicated to the MCD because, if the beacon 18 has not been moved, then the location information sent from the beacon 18 is assumed to be more reliable. The aforementioned beacon Model YJ-15044-Ibeacon has such an accelerometer 17.

In the preferred embodiment, the beacon 18 broadcasts a signal at predetermined fixed intervals (e.g., once every 5 minutes) to advertise its location and presence. Also, the beacon transmits advertising packets that contain information, for example, about the beacon's location and capabilities. The beacon 18 is programmed to go to a “sleep” mode after a certain amount of time not in use to conserve battery life. The beacon is equipped with a battery preferably having a long-term battery life, for example, 5 to 10 years.

Furthermore, depending upon the embodiment, each beacon signal can also indicate one or more of the following: (a) the terrestrial location with longitude and latitude coordinates, (b) an identity of the particular parcel of land and (c) an identify and terrestrial and/or relative location of one or more other boundary pins associated with a particular parcel.

### Bluetooth Low Energy

In the preferred embodiment, the beacon uses the Bluetooth Low Energy (BLE) communications protocol, which is encrypted. It can be combined with a secondary communication protocol (e.g., RFID; UWB, etc.) to increase location accuracy, consistency, and effectiveness (i.e., will be location accurate to about 0.1 inch). BLE utilizes the 2.4 GHz ISM band and a frequency hopping technique to spread its RF energy between multiple channels. Each property parcel (or lot) will have an assigned “family” of beacons 18, most likely four (4) per lot.

In the preferred embodiment, each of the four beacons 18 used to mark the property corners of a lot will be linked in their messaging to the other beacons 18 on the same lot. By associating the four beacons 18 at the corner of each lot, the beacons 18 within each lot family will be able to connect and interact with one another to calculate location information.

### Mobile Communications Device

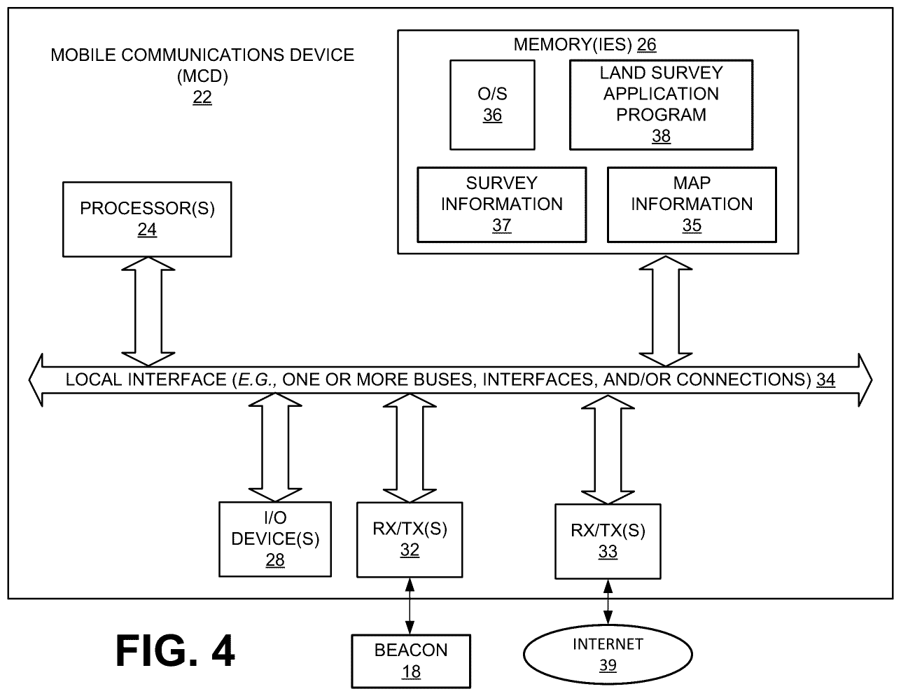

The MCD can be, for example but not limited to, a commercially available smartphone. FIG. 4 is a block diagram illustrating an example of the computer-based architecture of a smartphone 22.

With reference to FIG. 4, the MCD 22 includes at least a processor(s) 24 (or processing system), a memory (ies) 26, an input/output device (ies) (I/O) 28, and a bidirectional communications device(s) (transmitter/receiver or TX/RX) 32. The singular reference to these terms in this disclosure is intended to include the plural version, as well. All of the foregoing are communicatively coupled via a local interface(s) 34.

In terms of hardware, the memory 26 (a non-transitory computer readable medium) comprises all volatile and non-volatile memory elements, including but not limited to, RAM, ROM, etc. In terms of software, the memory 26 comprises at least the following software: a suitable operating system (O/S) 36 and the land survey application program 38, map information 35, and survey information 37. The computer program code (instructions) associated with the software in memory 26 is executed by the processor 24 in order to perform the methodologies of the present disclosure.

The land survey application program 38 (as well as the other software and software logic described in this document), which comprises an ordered listing of executable instructions for implementing logical functions, can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions. Furthermore, the land survey application program can be downloaded to a smartphone from cloud storage.

The input/output devices 28 may include, for example but not limited to, a keyboard, mouse, display, touch screen, etc.

The communications device 32 enables communications via the BLE protocol with the one or more beacons 18.

The communications device 33 enables communications to occur over the cellular network and/or the Internet 39. This communications device 33 can be used to access map information 35 and survey information 37, which can be stored in the memory 26.

When in operation, the MCD 22 connects with beacon 18 when nearby to wake the beacon 18. In this regard, the MCD 22 communicates by activating its built-in BLE scanner to routinely scan nearby area for the presence of any advertising packets. Once the MCD 22 detects the BLE signal from a nearby beacon 18, the MCD 22 (via the land survey application program) then decodes the advertising packets to ascertain the content and take appropriate action. In the event that secondary communications protocol is not built into MCD capabilities, an external device can be used that connects to MCD 22 (wired or wirelessly) to facilitate communications with beacons 18.

### Land Survey Application Program

The land survey application program 38 is designed to display the location of the beacons 18 on a display screen associated with the MCD 22. The land survey application program 38 displays satellite map image of property with the respective locations of beacons 18 overlayed on a map image. The land survey application program 38 is designed to implement wayfinding/RTLS in that the land survey application program 38 directs the user (via visual directions/cues) and displays real-time directions for the user so the user can move/walk to locate a beacon 18. The land survey application program 38 is designed to communicate with the user (via visual displays) when the user is getting closer to beacon 18. The land survey application program 38 can be designed to allow the user to command the beacon 18 to produce an audible chirp or other audible sound to assist in locating boundary pin. The land survey application program 38 can receive location data from one or more beacons 18 and display the precise locations on the MCD 22. The location of the MCD 22 can be calculated via triangulation between MCD 22 and two transmitters. If desired, the land survey application program 38 can utilize additional communications protocols (i.e., cellular, wifi, Bluetooth, etc.) in combination to improve location accuracy.

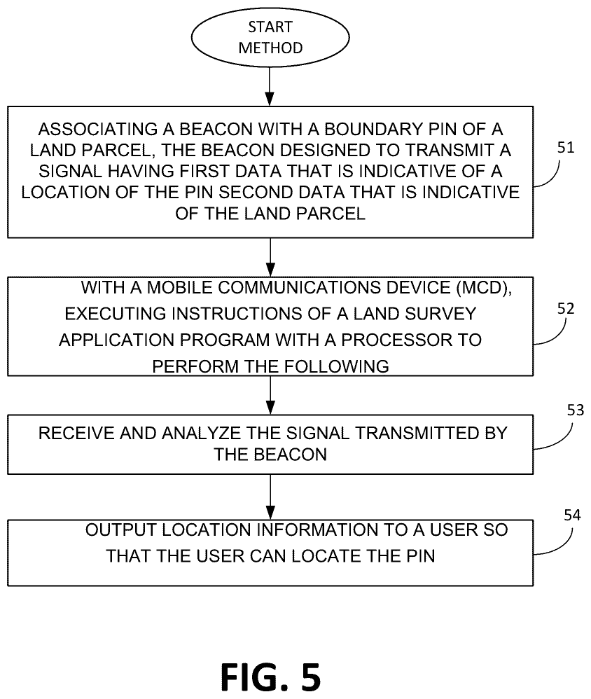

FIG. 5 is a flow chart illustrating a method having steps 51-54 that can be performed by the MCD 22 of FIG. 4, in accordance with the present disclosure, by executing instructions associated with the land survey application program 38.

In this regard, the first step 51 involves associating a beacon 18 with a boundary pin 14 of a land parcel. The boundary pin has an elongated body extending between first and second ends. The beacon 18 is associated with the first end, while the second end resides within the ground. The beacon 18 is designed to transmit a signal having first data that is indicative of a location of the pin and second data that is indicative of the land parcel; and

The second step 52 involves using the MCD 22 to execute instructions of the land survey application program 38 with the processor 24 in order to receive and analyze the signal transmitted by the beacon 18 and to output location information to a user so that the user can locate the pin 14.

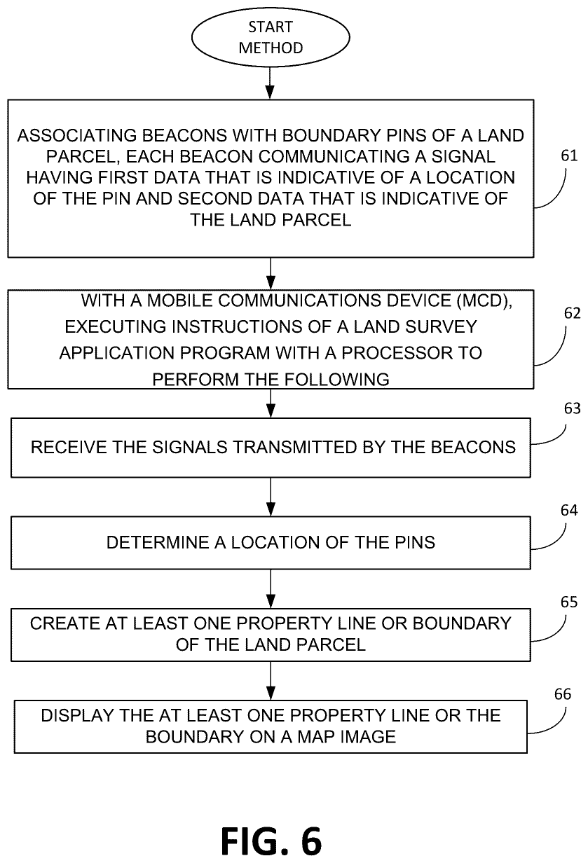

The land survey application program 38 can have instructions to create a boundary of the land identified by the pins 14 and to access map information 35 and display the land boundary overlaying the land on a map image, as illustrated in in the steps 61-66 of FIG. 6. Moreover, the land survey application program 38 may be provided with further instructions to display a feature inside the boundary of the land, for example, but not limited to, property set-back lines/areas, underground public utilities or pipes, easements, rights of way, etc., which can be obtained from the survey information 37.

### Augmented Reality:

In some embodiments, by using built-in camera associated with the MCD 22, the land survey application program 38 can be designed to implement augmented reality. In this regard, the land survey application program 38 can superimpose a virtual property line on the live camera image to illustrate to the user the precise location of the property line. The land survey application program 38 is able to display the property line by receiving the location coordinates from two adjacent beacons 18 and then displaying a (virtual) straight line on the camera's image. The augmented reality feature of the mobile land survey application program 38 can make the real time camera image appear as if there is an actual line drawn on the ground of the property (however, the line is only seen through the MCD's camera display). This feature is useful for eliminating boundary disputes.

Augmented reality can also be used to show the lines/locations of many different features/characteristics of the subject property, for example, the property's exact boundary line(s), the line representing certain building setback distance requirements, etc.

The land survey application program 38 can show any number of virtual objects as they relate to the property, e.g., the proposed location of a house or driveway, with survey grade accuracy of model placement. Accuracy of such model placement is a known weakness with current state of the art augmented reality technologies, which generally rely on GPS to place the models. Both the accuracy and precision of model placement by such current technologies is not up to survey grade standards.

### Additional/Alternative Embodiments

The beacon 18 can also be designed with capabilities for broader communications to a network, for example, cellular or wifi. Broader communication can allow for a real time display showing the actual property grid lines for a community/development. This is a significant improvement to existing options, which can only show a drawing of where the property lines are planned to be. Builders/developers can see the various properties/lots in a community (before, during or after construction) as they exist in accordance with the physical boundary monuments (i.e. not a plan or plat showing how property lines/lots should exist).

The signal broadcast by the beacon 18 can be encrypted using tokenization (blockchain technology) incorporated to ensure security and accuracy. This feature can be critical for potential use by title companies.

The land survey application program 38 may be designed to interface with Google Maps, Zillow, Realtor.com, etc. With this information, existing web-based satellite imagery may be displayed with purported property lines overlayed on satellite image. These property lines are estimated property lines obtained from construction plats/drawings filed with local municipalities. All properties with the beacons 18 installed allows for precise display of property lines.

The beacon 18 can be designed to use UWB (ultra wide band) for communication sessions.

The beacon 18 can be designed with an RFID tag.

Signal receptor/repeater/module can be installed nearby (i.e. one or two per community/development) to assist with the process of communicating signals from beacons 18.

Two or more communications protocols and/or frequencies may be combined to achieve higher level of location accuracy.

The beacon 18 can also be designed to send out ultrasound signals. In this case, an ultrasound receiver can be associated, internally or externally, with the MCD 22.

### Example of Use

The following example describes how a potential end-user (i.e., Construction Company X) might use the invention.

Construction Company X (hereinafter, the “builder”) is preparing to begin the construction of a commercial office building on a piece of property owned by a land developer (hereinafter, the “developer”). In addition to the 5-story office building, the site will also include an adjacent parking garage and a water retention pond as well. The site is large enough to fit the proposed building, parking garage, and retention pond, but everything must be built precisely where it is planned to meet the local building, zoning and land use regulations.

Prior to grading the property, the developer contracted with a professional land surveying company to perform a boundary survey. The property surveyor marked the property boundary corners with the installation of boundary pins 14. This time, however, the surveyor installed the boundary pins 14 with the new tech-enabled pin caps 16 having beacons 18.

Now that the property has been properly graded and is ready for construction to begin, a three-person management team from the builder plans to walk the property (as they do prior to beginning each project) to see the site in-person. While on site, the team becomes confused and disoriented regarding the exact location of the property's rear boundary line. The bare dirt that was moved and exposed during the grading process makes the property look very different at this point than it had before, so it is now difficult to establish where the property lines are.

The builder then opens the land survey application program 38 on his MCD 22, chooses the appropriate property location (address), and then selects the back left property corner marker (by simply touching the back left corner of the property, which is displayed via the land survey application program 38). The land survey application program 38 establishes a seemingly instantaneous digital connection with the back left property boundary pin 14, which is communicated to the user by highlighting and focusing on the chosen boundary corner.

The builder then selects a “Locate” option within the land survey application program 38, which initiates the real-time location function of the land survey application program 38 (i.e., wayfinding mode). This function helps the builder locate the back left corner of the property by directing movement in the direction of the boundary pin 14 until it is located.

While holding the MCD 22, the land survey application program 38 displays a large blinking arrow pointing in the direction of the boundary pin 14, along with the exact distance between the boundary pin 14 and the MCD 22 (shown below the large arrow). As the builder walks in the direction of the arrow shown on the screen, the arrow blinks, turns green, and the distance decreases with each step, indicating to the that builder is walking in the correct location to get closer to the boundary pin 14.

The arrow continues to direct the builder to walk in the direction of the boundary pin 14. Once the builder is within a 3 foot radius of the boundary pin 14, the land survey application program 38 signals a chime and the icon of the boundary pin 14 begins blinking. At this point, the land survey application program 38 provides an option for the user to cause the boundary pin 14 to emit a ping or chirp sound, which is audible, to help locate the precise location of the pin. This is particularly useful for the builder because the boundary pin 14 was covered with dirt during the grading process.

The audible chirp signals the location of the boundary pin 14, and after removing a few inches of loose dirt covering the pin 14, the builder can visually locate the pin cap 16.

While standing nearby, the builder selects a “Display Property Line” option in the land survey application program 38. This function initiates the MCD's camera application and immediately displays a live view on the device's display (as if the builder were preparing to take a photo). The builder aims the device's camera toward the ground. The land survey application program 38, which has now connected with the property's other boundary pins 14, displays a bright white line on the image shown on the device that traces the exact location of the property's rear boundary line.

To the builder, the line appears to be displayed on the ground of the property itself; however, the land survey application program 38 is using augmented reality to only make it appear as such. The app's display showing the precise location of the (virtual) property line makes things far clearer and re-orients the builder to the property, allowing the group to continue its discussion and analysis.

A time later, for example, three weeks later, the construction crew might arrive on site and prepares to initiate construction.

In accordance with the site plan that was filed with and approved by the local municipality, the southwest corner of parking garage is to be built within 2 inches of the building set back line on the property. As such, the concrete crew must be extremely careful to pour the garage's foundation in the precisely correct location shown in the site plan. To be sure there are no mistakes, the builder can personally be on site to oversee the process.

Just prior to pouring the concrete—with the concrete forms set up and in place—The builder walks to the southwest corner of the foundation and opens the land survey application program 38 on his MCD 22. The builder selects the “Set Back Line Display” option within the land survey application program 38 and points the camera of his MCD 22 towards the ground.

The land survey application program 38 displays a virtual white “line” on the ground of the image shown on the device's display to signify the precise terrestrial location of the property's set back line. The builder is able to personally confirm that the foundation, once poured, will be correctly situated on the property and will not encroach on the setback line.

At several points throughout the project, the builder is able to utilize the land survey application program 38 to see survey-grade, real-time location and position information to ensure construction progresses correctly. The land survey application program 38 also is useful post-construction.

When construction is finalized, the anchor tenant for the property might request that the builder include a privacy fence on the eastern border of the property. The fence company could request that the builder mark the property to show the exact location where the fence was to be installed because the fence company did not want to construct the fence on the neighboring property by mistake.

In this case, the builder is able to place stakes at 10 feet increments along the portion of the property where the fence was to be built simply by utilizing the land survey application program 38 to display the location of the property line. The builder can hold his/her MCD 22 while an associate carefully drove the wooden stakes into the ground along the property line.

Finally, a time after construction was completed, say 3 years, a neighboring property owner might complain about landscaping that was apparently planted over the property line. The builder is able to meet with the neighboring landowner to show the location of the exact property line, ending the potential dispute.

### Advantages Summary

The following summarizes the main advantages of the embodiments of the present invention:
1) An Easier, Simpler, and More Reliable Method of Locating Property Boundary Markers—The invention allows an end user to physically locate hidden or covered (or otherwise unlocatable) property boundary markers by using a land survey application program 38 on an MCD 22 that displays the survey markers' precise location(s) while providing audible and visual directional instructions/cues to assist in locating (i.e., wayfinding to the correct location),
2) Real-Time, On Site Location/Positioning—The invention allows an end user to determine, in real time, an MCD's precise location and position on the property (i.e., survey-grade location data), which ultimately can reduce (or even eliminate) having to use or rely on professional surveying equipment when precise location/position data is needed (i.e. a user can determine the exact location to situate a structure's foundation via a land survey application program 38 on an MCD 22),
3) Electronic Equipment Calibration with Local Coordinate System—The invention provides a far better method (i.e., quicker, easier and simpler) for calibrating equipment with the property's local coordinate system—a required step all professional land surveyors must execute prior to initiating any on-site measurements—thereby eliminating the need to locate and use pre-established survey “control point” locations for calibration.
4) Provides a More Accurate Method of Formally Establishing/Recording Property Lines & Boundaries—The invention creates a system in which the official and formally recorded property boundaries of the land parcels within a given jurisdiction correspond to the boundary markers installed in the ground (instead of a recorded drawing from a land surveyor)

At least the following is claimed:

1. An apparatus, comprising:
a boundary pin, the boundary pin having an elongated body extending between first and second ends;
a beacon, the beacon mounted to the boundary pin, the beacon designed to transmit a signal to a mobile communications device (MCD), the signal indicative of location information pertaining to the pin.

2. The apparatus of claim 1, wherein the first end of the boundary pin reside within the ground.

3. The apparatus of claim 1, wherein the signal is a radio frequency (RF) carrier signal having data encoded thereon, the data indicative of the location information.

4. The apparatus of claim 3, wherein the data indicates at least a direction of the combination of the pin and beacon apparatus relative to the MCD.

5. The apparatus of claim 3, wherein the RF signal conforms to the Bluetooth Low Energy (BLE) protocol.

6. The apparatus of claim 1, wherein the beacon is designed to communicate data to and from the MCD and wherein the beacon further comprises a sound generator that can be activated by particular data received from the MCD.

7. The apparatus of claim 1, wherein the beacon is designed to communicate data to and from the MCD and wherein the beacon further comprises an accelerometer that provides particular data to the MCD indicating whether the beacon has been moved.

8. A system comprising the apparatus of claim 1 and the MCD, wherein the MCD comprises a user interface output that indicates a direction of the apparatus relative to the MCD.

9. The apparatus of claim 1, further comprising a pin cap and wherein the pin cap, the beacon, and the pin are secured together.

10. The apparatus of claim 1, wherein the signal is indicative of the location information pertaining to the pin relative to the MCD.

11. A system comprising:
a plurality of boundary pins that identifies a boundary of a particular parcel of land;
a plurality of beacons associated with respective boundary pins, each beacon designed to transmit a signal, each signal indicative of a respective location of the respective pin; and
a mobile communications device (MCD), the MCD having a processing system that executes instructions associated with a land survey application program, the land survey application program designed to receive the signals transmitted by the beacons and to output location information to a user so that the user can locate the plurality of pins.

12. The system of claim 11, wherein each signal is also indicative of at least one of the following: (a) the terrestrial location with longitude and latitude coordinates, (b) an identity of the particular parcel of land and (c) an identify and terrestrial and/or relative location of one or more other boundary pins associated with the particular parcel.

13. The system of claim 11, wherein the land survey application program further comprises instructions to create a boundary of the land identified by the pins.

14. The system of claim 13, wherein the land survey application program further comprises instructions to access map and survey information and display the land boundary overlaying the land on a map.

15. The system of claim 14, wherein the land survey application program further comprises instructions to display a feature inside the boundary of the land.

16. The system of claim 11, wherein each beacon is designed to communicate data to and from the MCD and wherein each beacon further comprises a sound generator that can be activated by particular data received from the MCD in order to assist the user in locating the pins.

17. The system of claim 11, wherein the beacon is designed to communicate data to and from the MCD and wherein the beacon further comprises an accelerometer that provides particular data to the MCD indicating whether the beacon has been moved.

18. The system of claim 11, wherein each signal is a radio frequency (RF) carrier signal having data encoded thereon, the data indicative of the location information.

19. The system of claim 18, wherein the RF signal conforms to the Bluetooth Low Energy (BLE) protocol.

20. A pin cap for placement on a boundary pin, the pin cap comprising a beacon designed to transmit a signal, the signal indicative of a location of the pin cap.

21. The pin cap of claim 20, wherein the signal is in the radio frequency range.

22. The pin cap of claim 21, wherein the signal complies with the Bluetooth Low Energy protocol.

23. The pin cap of claim 20, wherein the beacon is designed to transmit and receive data and wherein the beacon further comprises a sound generator that can be activated to make a sound by particular data received from the MCD.

24. The pin cap of claim 20, wherein the beacon is designed to communicate data to and from the MCD and wherein the beacon further comprises an accelerometer that provides particular data the MCD indicating whether the beacon has been moved.

25. A method, comprising the steps of:
associating a beacon with a boundary pin of a land parcel, the boundary pin having an elongated body extending between first and second ends, the beacon being associated with the first end, the second end residing within the ground, the beacon designed to transmit a signal, the signal having first data that is indicative of a location of the pin; and
with a mobile communications device (MCD), executing instructions of a land survey application program with a processor in order to receive and analyze the signal transmitted by the beacon and to output location information to a user so that the user can locate the pin.

26. The method of claim 25, wherein the signal is also indicative of at least one of the following: (a) the terrestrial location with longitude and latitude information, (b) an identity of the particular parcel of land and (c) an identify and terrestrial and/or relative location of one or more other boundary pins associated with the particular parcel.

27. The method of claim 25, wherein the beacon further comprises a sound generator that can be activated by particular data received from the MCD in order to assist the user in locating the pins and further comprising the step of communicating data from the MCD to the beacon to cause the sound generator to emit a sound.

28. The method of claim 25, wherein the signal is a radio frequency (RF) carrier signal having data encoded thereon, the data indicative of the location information.

29. The method of claim 28, wherein the RF signal conforms to the Bluetooth Low Energy (BLE) protocol.

30. The method of claim 25, further comprising the steps of receiving data from an accelerometer associated with the beacon and determining whether the beacon has been moved based upon the data.

31. A system comprising:
a plurality of boundary pins that identifies a boundary of a particular parcel of land;
a plurality of beacons associated with respective boundary pins, each beacon designed to transmit a signal, each signal indicative of a respective location of the respective pin; and
a mobile communications device (MCD), the MCD having a processing system that executes instructions associated with a land survey application program, the land survey application program designed to receive the signals transmitted by the beacons, to determine a location of the pins, to create at least one property line of the land parcel, and to display the at least one property line on a map image.

32. The system of claim 31, wherein each signal is also indicative of at least one of the following: (a) the terrestrial location with longitude and latitude coordinates, (b) an identity of the particular parcel of land and (c) an identify and terrestrial and/or relative location of one or more other boundary pins associated with the particular parcel.

33. The system of claim 31, wherein the land survey application program further comprises instructions to access map and survey information via the internet.

34. The system of claim 31, wherein the land survey application program further comprises instructions to display a feature inside the boundary of the land.

35. The system of claim 31, wherein each beacon is designed to communicate data to and from the MCD and wherein each beacon further comprises a sound generator that can be activated by particular data received from the MCD in order to assist the user in locating the pins.

36. The system of claim 31, wherein the beacon is designed to communicate data to and from the MCD and wherein the beacon further comprises an accelerometer that provides particular data to the MCD indicating whether the beacon has been moved.

37. The system of claim 31, wherein each signal is a radio frequency (RF) carrier signal having data encoded thereon, the data indicative of the location information.

38. The system of claim 31, wherein the land survey application program creates a complete boundary of the land parcel and displays the boundary on a map image.

39. The system of claim 37, wherein the RF signal is a Bluetooth Low Energy (BLE) signal.

40. A method, comprising the steps of:
associating a beacon with a boundary pin of a land parcel, the boundary pin having an elongated body extending between first and second ends, the beacon being associated with the first end, the second end residing within the ground, the beacon designed to transmit a signal, the signal having first data that is indicative of a location of the pin; and
with a mobile communications device (MCD), executing instructions of a land survey application program with a processor in order to receive the signals transmitted by the beacons, to determine a location of each of the pins, to create at least one property line of the land parcel, and to display the at least one property line on a map image.
